(19) United States
(12) Patent Application Publication
(10) Pub. No.: US 2013/0188970 A1
(43) Pub. Date: Jul. 25, 2013

(54) Packaging Platform For Opto-Electronic Assemblies Using Silicon-Based Turning Mirrors

(71) Applicants: Kalpendu Shastri, Orefield, PA (US); Vipulkumar Patel, Breinigsville, PA (US); Soham Pathak, Allentown, PA (US); Utpal Chakrabarti, Allentown, PA (US); Bipin Dama, Bridgewater, NJ (US); Ravinder Kachru, Los Altos Hills, CA (US); Kishor Desai, Fremont, CA (US)

(72) Inventors: Kalpendu Shastri, Orefield, PA (US); Vipulkumar Patel, Breinigsville, PA (US); Soham Pathak, Allentown, PA (US); Utpal Chakrabarti, Allentown, PA (US); Bipin Dama, Bridgewater, NJ (US); Ravinder Kachru, Los Altos Hills, CA (US); Kishor Desai, Fremont, CA (US)

(21) Appl. No.: 13/745,773

(22) Filed: Jan. 19, 2013

Related U.S. Application Data
(60) Provisional application No. 61/588,304, filed on Jan. 19, 2012.

(51) Int. Cl. H04B 10/12

(52) U.S. Cl. CPC H04B 10/501
USPC 398/201; 29/592.1

(57) ABSTRACT

An apparatus for transmitting optical signals includes an interposer for supporting opto-electronic components used to create optical output signals. An enclosure is used to encapsulate the populated interposer assembly and includes a silicon sidewall and a transparent lid. The sidewall is etched to include a turning mirror feature with a reflecting surface at a predetermined angle θ, the turning mirror disposed to intercept the optical output signals and re-direct them through the enclosure's transparent lid. A coverplate is disposed over and aligned with the enclosure, where the coverplate includes a silicon sidewall member that is etched to include a turning mirror element with a reflecting surface at the same angle θ as the enclosure's turning mirror element. The optical signals re-directed by the enclosure then pass through the transparent lid of the enclosure, impinge the turning mirror element of the coverplate, and are then re-directed along the longitudinal axis.

### CROSS-REFERENCE TO RELATED APPLICATIONS

This application claims the benefit of U.S. Provisional Application No. 61/588,304, filed Jan. 19, 2012 and herein incorporated by reference.

### TECHNICAL FIELD

The present disclosure relates to opto-electronic assemblies including silicon-based turning mirrors to direct one or more optical output signals along a preferred direction.

### BACKGROUND

Many types of opto-electronic modules comprise a number of separate optical and electrical components that require precise placement relative to one another. A silicon (or glass) carrier substrate (sometimes referred to as an interposer) is generally used as a support structure to fix the location of the components and may, at times, also provide the desired electrical or optical signal paths between selected components. As the components are being assembled on the interposer, active optical alignment may be required to ensure that the integrity of the optical signal path is maintained.

The direction of the optical output signal paths is generally maintained along a common plane, with a fiber array containing several individual fibers used as the optical signal path between the interposer and the external communication environment. Integrated waveguides may be used in place in fibers. Most configurations utilize an array connector that is permanently attached to the interposer housing, since the need to reliably maintain optical alignment is a primary concern.

However, it is desirable to use a removable connector. Additionally, it is preferred to use a connector that does not need to physically contact any of the elements disposed on the interposer (that is, maintain the integrity of an encapsulated interposer arrangement).

### BRIEF DESCRIPTION OF THE DRAWINGS

The accompanying drawings, which are incorporated in and constitute a part of this disclosure, illustrate various embodiments of the present invention. In the drawings:

FIG. 1 is an isometric view of an opto-electronic module assembly of a particular embodiment of the present invention, illustrating a silicon-based turning mirror arrangement;

FIG. 2 is a simplified diagram illustrating the use of a known etchant that will preferentially etch a silicon substrate to form angled sidewalls;

FIG. 3 illustrates an exemplary enclosed interposer, using a silicon-based sidewall turning mirror to re-direct an array of optical output signals through the transparent lid;

FIG. 4 is an isometric view of the encapsulate interposer arrangement as shown in FIG. 3, in combination with a coverplate including a second silicon-based turning element for re-directing the optical output signals back along the original optical axis OA;

FIG. 5 is a simplified side view illustration of the use of a pair of etched turning elements formed in silicon to provide for re-direction of one or more optical output signals from an opto-electronic assembly (not explicitly shown);

FIG. 6 is an isometric view of an arrangement for directing optical output signals from an enclosed interposer supporting an opto-electronic assembly including an optical transmitter; and

FIG. 7 is an isometric view of an exemplary combination of the arrangement as shown in FIG. 6 with a connector containing an array of optical signal paths for removably coupling with optical output signals O.

### DESCRIPTION OF EXAMPLE EMBODIMENTS

### Overview

An apparatus for transmitting optical signals includes an interposer for supporting opto-electronic components used to create optical output signals. An enclosure is used to encapsulate the populated interposer assembly and includes a silicon sidewall and a transparent lid. The sidewall is etched to include a turning mirror feature with a reflecting surface at a predetermined angle θ, the turning mirror disposed to intercept the optical output signals and re-direct them through the enclosure's transparent lid. A coverplate is disposed over and aligned with the enclosure, where the coverplate includes a silicon sidewall member that is etched to include a turning mirror element with a reflecting surface at the same angle θ as the enclosure's turning mirror element. The optical signals re-directed by the enclosure then pass through the transparent lid of the enclosure, impinge the turning mirror element of the coverplate, and are then re-directed along the longitudinal axis.

### Example Embodiments

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

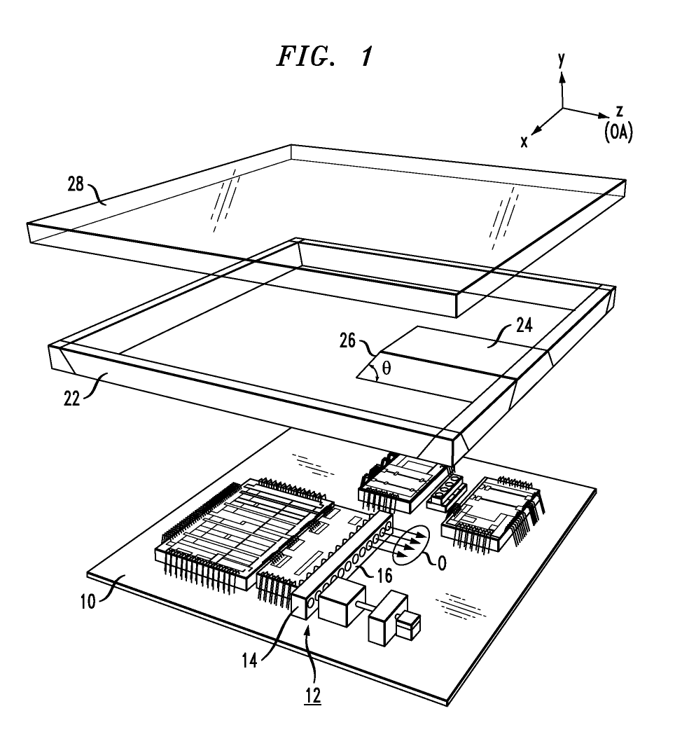

FIG. 1 is an isometric view of an opto-electronic module assembly of a particular embodiment of the present invention, illustrating a silicon-based turning mirror arrangement. As shown in FIG. 1, the arrangement utilizes an interposer substrate 10 that may comprise any suitable material, where silicon and glass materials are conventional choices for this purpose and provide the desired flat top surface that is defined as a reference plane for optical alignment purposes.

The utilization of a silicon or glass interposer as an optical reference plane allows for optical components with precision heights (e.g., lasers, lenses, photodiodes, etc.) to be placed on surface S of interposer 10 with photolithographic accuracy, while also maintaining the ability for wafer scale assembly. In this case, FIG. 1 illustrates an exemplary silicon interposer 10 and a plurality of various optical components 12 utilized to create one or more optical output signals (O). These optical components include, for example, a laser source (which may be a single source or a laser array), focusing optics, and an opto-electronic integrated circuit for creating one or more optical communication signals (based on electrical input data). In the embodiment as shown in FIG. 1, the plurality of optical components 12 includes a lens array 14 that is used to collimate the optical output signals O as created by the opto-electronic integrated circuit.

Since the surface of interposer 10 creates an optical reference plane, the location of the individual lens elements 16 of lens array 14 with respect to top surface S of interposer 10 is known and controlled in a repeatable manner across the surface of a silicon wafer which may form the basis of multiple interposers. Also, the position and direction of optical output signals O with respect to interposer 10 is known and well-controlled. In this example, optical output signals O are shown to be parallel to the illustrated z-axis, which is now defined as the longitudinal optical axis OA of the system.

While allowing optical output signals O to exit interposer 10 along longitudinal axis OA, it may be preferable to avoid the need to directly couple an associated optical signal connector (such as a fiber or waveguide array) to interposer 10. The arrangement as illustrated in FIG. 1 eliminates this need by utilizing a silicon-based interposer enclosure that includes a sidewall turning mirror for re-directing optical output signals O out of the plane of the interposer.

Referring to FIG. 1, an enclosure 20 is used to completely encapsulate the opto-electronic components disposed on interposer 10, while allowing optical output signals O to pass through unimpeded. As shown enclosure 20 includes a silicon sidewall member 22 which is formed to include a turning mirror element 24 that aligns to intercept optical output signals O when silicon sidewall member 22 is attached to interposer 10. Turning mirror element 24 is formed to include an angled reflecting surface 26.

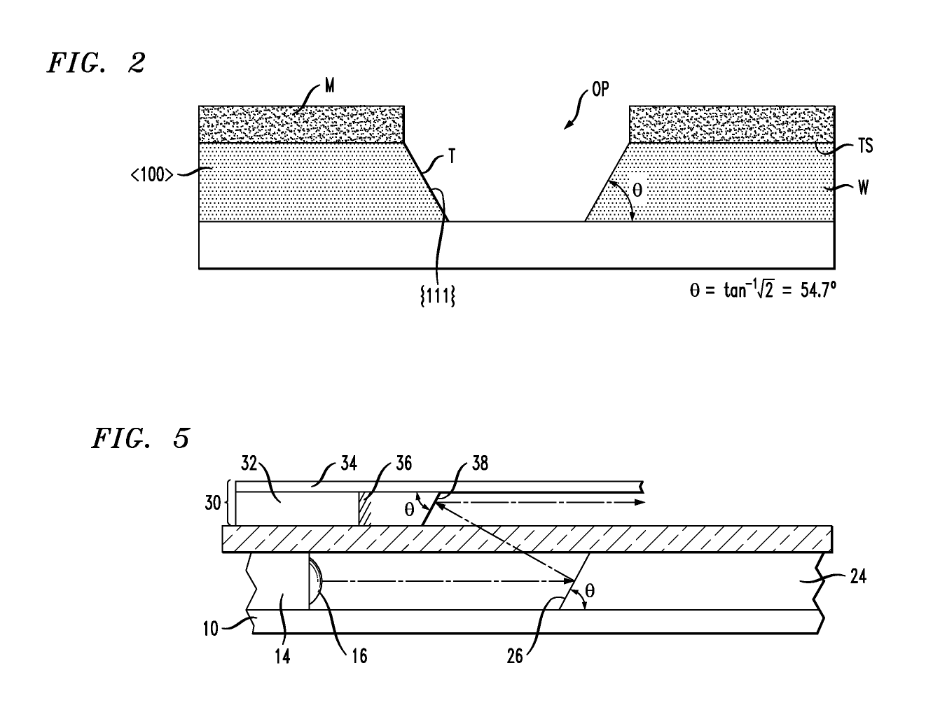

In accordance with this embodiment of the present invention, the use of silicon to form sidewall member 22 allows for a conventional anisotropic etching process to be used to form angled reflecting surface 26. FIG. 2 is a simplified diagram illustrating the use of a known etchant that will preferentially etch a silicon substrate to form angled sidewalls. Referring to FIG. 2, a silicon wafer W is shown as is presumed to be oriented along the <100> crystallographic plane. A masking material M is shown as covering a majority of a top surface TS of wafer W, leaving an opening OP. When an anisotropic etchant is applied to this masked structure, the etchant will preferentially remove the silicon material along the <100> plane (that is, etch more quickly “across” the wafer than “through” the wafer), resulting in the structure as shown in FIG. 2. This structure includes tapered sidewalls T that exhibit an angle θ of 54.7° (which is tan⁻¹\sqrt{2}) as shown in FIG. 2. The use of an anisotropic etchant for forming tapered sidewalls in a silicon structure is a well-known procedure in the process of forming integrated circuit devices. A variety of different etchants are suitable for this purpose, including, for example, potassium hydroxide (KOH) or any of the quaternary ammonium hydroxides, such as tetramethyl ammonium oxide, or TMAH). Regardless of the material used to perform the etching, the preferential removal of silicon along one crystallographic plane with respect to another will consistently and repeatedly create angled sidewalls at an orientation of 54.7°.

By virtue of using a silicon wafer as the starting material for enclosure 20, it is clear that a plurality of silicon-based sidewall members 22 can be simultaneously formed as a part of a wafer scale fabrication process, starting with a silicon wafer of the preferred <100> orientation. The wafer is properly patterned and masked to delineate the separate locations of individual sidewall members across the surface of the wafer, with the patterning of each sidewall member 22 controlled to define the location of turning mirror element 24. Thereafter, the application of an anisotropic etchant across the wafer surface will preferentially etch the exposed silicon regions, creating the separate enclosures and turning mirror elements in their desired locations.

Referring back to FIG. 1, optical output signals O are shown as exiting the plurality of individual lens elements 16 forming lens array 14. Optical output signals O will then intercept angled reflecting surface 26 of turning mirror element 24 (angled at 54.7°) and then be re-directed back at an angle of 109.4° out of the plane of the interposer. Enclosure 20 further includes a transparent lid 28 which allows the re-directed optical output signals to pass through enclosure 20 unimpeded.

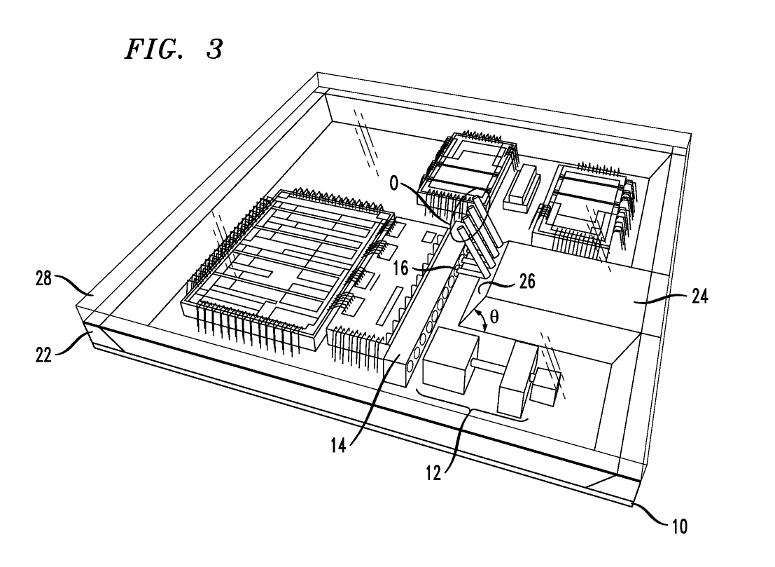

FIG. 3 illustrates an exemplary enclosed interposer, using a silicon-based sidewall turning mirror to re-direct an array of optical output signals through the transparent lid. Referring to FIG. 3, silicon sidewall member 22 is attached to interposer 10, where sidewall member 22 is configured to outline and enclose all of the individual opto-electronic components as disposed on interposer 10. Further silicon sidewall member 22 is positioned such that silicon turning mirror element 24 is properly aligned with the optical output signals O as created by the components on the interposer. As described above, turning mirror element 24 includes an angled reflecting surface 26 that is formed during an anisotropic etch process so that optical output signals O will reflect off of angled surface 26 and be re-directed through transparent lid 28 and away from interposer 10.

In some embodiments, angled reflecting surface 26 may be coated with a metallic material (or a stack of dielectric materials) to increase its reflectivity and ensure that a sufficient power of optical signal is re-directed in the manner shown and does not continue to propagate through turning mirror element 24. Transparent lid 28 may be coated with an anti-reflective material to minimize reflections at either its interior or exterior surface.

In one embodiment of the arrangement as shown in FIG. 3, enclosure 20 may be attached to interposer 10 using a process that creates a hermetic encapsulation, which may be preferred for some applications. In any case, it is shown that enclosure 20 is positioned over and attached to interposer 10, the resulting structure is completely sealed and no extraneous debris or contaminants will later be able to enter and disrupt the performance of the optical devices.

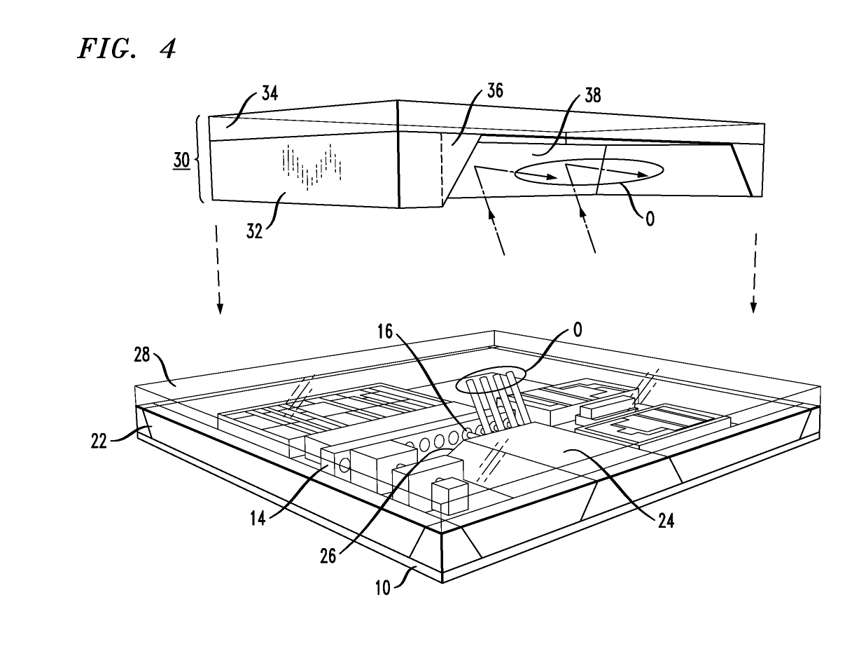

FIG. 4 is an isometric view of the encapsulate interposer arrangement as shown in FIG. 3, in combination with a coverplate including a second silicon-based turning element for re-directing the optical output signals back along the original optical axis OA. In particular, FIG. 4 illustrates the combination of interposer 10 and enclosure 20 as described above, showing the re-direction of optical output signals O by angled reflecting surface 26 so that they pass through transparent lid 28 of enclosure 20. Also shown in FIG. 4 is a coverplate 30 which includes a silicon sidewall member 32 and a lid 34. In a similar fashion to the fabrication process discussed above, silicon sidewall member 32 is subjected to an anisotropic etching process to form a turning mirror element 36 including an angled reflecting surface 38. As with enclosure 20, when using a <100> silicon wafer to form coverplate 30, an anisotropic etching process forms tapered sidewalls exhibiting an angle of 54.7 with respect to the wafer surface, creating turning mirror element 36 with angled reflecting surface 38.

The aligned placement of coverplate 30 on enclosure 20 allows for optical output signals O to intercept surface 38 of turning mirror element 36 where, as shown FIG. 4, optical signals O will again be re-directed, in this instance to again propagate along the longitudinal optical axis OA of the system.

FIG. 5 is a simplified side view illustration of the use of a pair of etched turning elements formed in silicon to provide for re-direction of one or more optical output signals from an opto-electronic assembly (not explicitly shown). Referring to FIG. 5, an optical output beam O is shown as exiting from lens element 16 of lens array 14 (inasmuch as this is a side view, only a single light beam and lens element are visible). Optical output beam O is shown as impinging on angled reflecting surface 26 of turning mirror element 24 and being re-directed upward and out of the plane of interposer 10. As shown, re-directed optical output beam O passes through transparent lid 28 of enclosure 20 and then enters coverplate 30, which has been attached to enclosure 20 in a properly aligned configuration (using passive or active alignment, as desired).

Optical output beam O next impinges turning mirror element 36 of coverplate 30. Since the angle of turning mirror element 36 is the same as the angle of turning element 24, optical output beam O will be re-directed along the original optical axis OA, albeit having been translated upward (along the y-axis in this view) to a region where connection to an associated optical signal can be made without needing to contact any of the opto-electronic components disposed on interposer 10. As with angled reflecting surface 26, angled reflecting surface 38 may be coated with a reflective material, such as a metal (or a stack of dielectric materials), to minimize the optical power that is coupled into turning mirror element 36. For embodiments that also include optical receiving elements, lid 34 of coverplate 30 may be transparent and provide an unimpeded input optical signal path through both lid 34 and lid 28, directing incoming optical signals into photodiodes disposed in a pre-defined location on interposer 10.

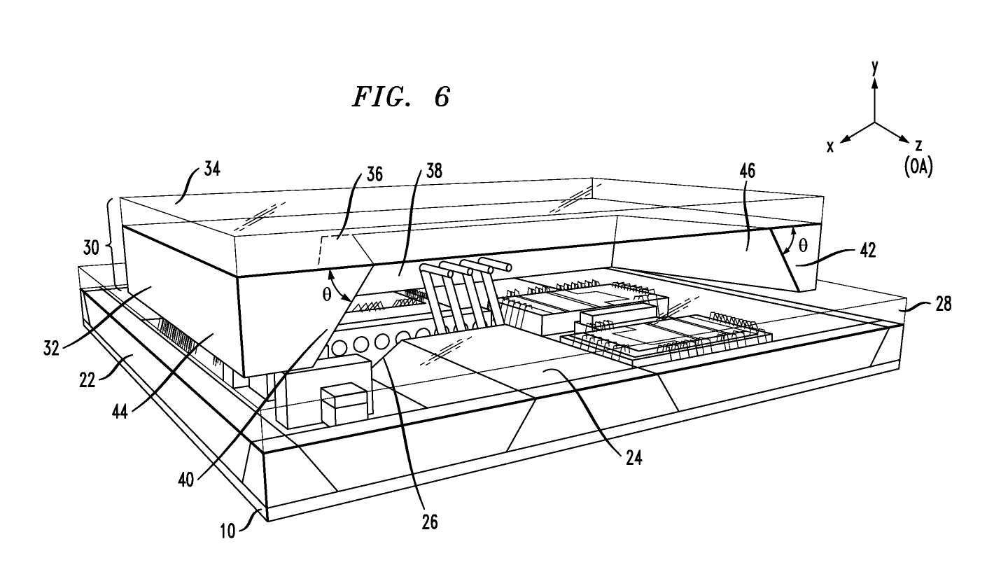

FIG. 6 is an isometric view of an arrangement for directing optical output signals from an enclosed interposer supporting an opto-electronic assembly including an optical transmitter. In particular, FIG. 6 is a view of the arrangement as shown in FIG. 4, with coverplate 30 attached to enclosure 20 in a properly aligned arrangement. By virtue of being “properly aligned”, optical output signals O reflecting off of angled reflecting surface 26 of turning mirror element 24 will then propagate through transparent lid 28 and then impinge angled reflecting surface 38 of turning mirror element 36. When properly aligned, the optical output signals then exit the arrangement along the longitudinal optical axis OA, as shown in FIG. 6.

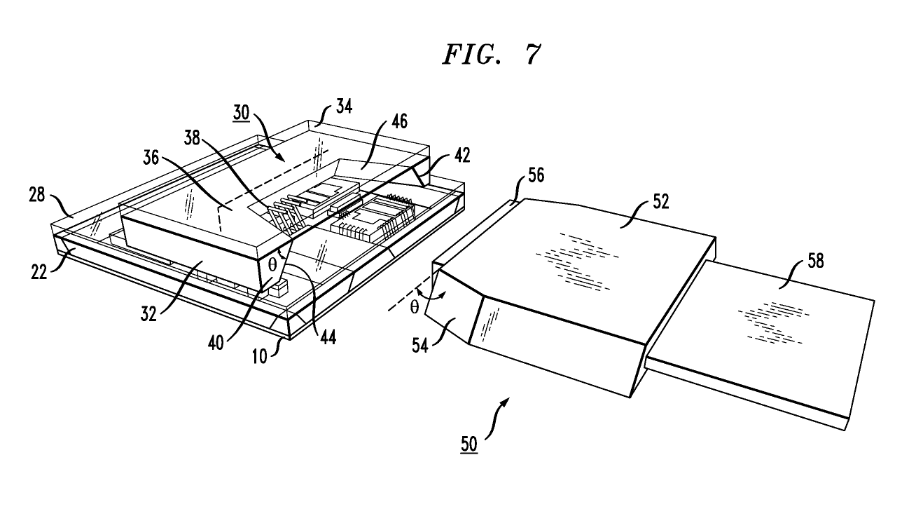

Also shown in the embodiment of FIG. 6 is a pair of connector guiding features 40, 42 formed along associated surfaces 44, 46 of silicon sidewall member 32. In particular, connector guiding features 40, 42 are disposed on either side of turning mirror element 36, forming a U-shaped opening within coverplate 30. Guiding features 40, 42 are used to properly position an associated connector (not shown in FIG. 6) within the opening formed within coverplate 30 in a manner where output optical signals O are directly coupled into associated optical signal paths within the connector. In accordance with the use of silicon to form sidewall member 32, guiding features 40 and 42 can best be formed by preferentially etching the starting silicon wafer to form angled surfaces at the same angle θ along surfaces 44 and 46. The length L of the guiding features (as shown in the following FIG. 7) is defined by the mask pattern as used on the surface of the silicon wafer.

FIG. 7 is an isometric view of an exemplary combination of the arrangement as shown in FIG. 6 with a connector containing an array of optical signal paths for removably coupling with optical output signals O. Referring to FIG. 7, a silicon-based array connector 50 is shown as comprising a silicon housing 52 including a pair of guiding features 54, 56 which will mate with guiding features 40, 42 of silicon sidewall member 32 when array connector 50 is positioned in place within the U-shaped opening in coverplate 30. If necessary, an anti-stiction material may be applied as a coating on guiding features 40, 42, 54 and 56 to facilitate the movement of one element with respect to the other. Indeed, in one embodiment, the arrangement is configured such that array connector 50 can be removably coupled to coverplate 30; that is, where the array connector may be attached to and then subsequently removed from the optical assembly.

Inasmuch as housing 52 is formed of silicon, guiding features 54 and 56 may again be formed using an anisotropic etching process so that these features also exhibit the same taper angle θ as guiding features 40, 42. In this particular arrangement, a separate lens array 58 is disposed at the exit of connector array 50 and is used to focus the propagating optical output signals O into the associated signal paths 60 within array connector 50.

In one embodiment, signal paths 60 may comprise an array of optical fibers. In an alternative embodiment, signal paths 60 may comprise an array of integrated optical waveguides (perhaps including nanotapers coupling regions) disposed within silicon-based connector housing 52. Regardless of the details of the signal paths, the use of silicon to form the coupling features and turning mirrors results in a final arrangement where alignment is achieved by taking advantage of the taper angle created by etching along a crystallographic plane of the silicon material.

While the invention has been described in terms of different embodiments, those skilled in the art will recognize that the invention can be practiced with various modifications that are considered to fall within the spirit and scope of the invention as best defined by the claims appended hereto. Furthermore, while the specification has been described in language specific to structural features and/or methodological acts, the claims are not limited to the features or acts described above. Rather, the specific features and acts described above are disclosed as examples for embodiments of the invention.

What is claimed is:

1. An apparatus comprising
an interposer substrate for supporting a plurality of opto-electronic components for creating optical output signals propagating along a longitudinal optical axis
an enclosure covering the interposer substrate, the enclosure including a silicon sidewall member and a transparent lid, the silicon sidewall member etched to include a turning mirror element with a reflecting surface at a predetermined angle θ, the turning mirror element for intercepting the created optical output signals and re-directing the created optical output signals through the transparent lid; and
a coverplate disposed over and aligned with the enclosure, the coverplate including a silicon sidewall member etched to include a turning mirror element with a reflecting surface at the same predetermined angle θ, the coverplate turning mirror element for re-directing the optical output signals along the longitudinal axis.

2. The apparatus as defined in claim 1 wherein the enclosure silicon sidewall member and the coverplate silicon sidewall member are formed of <100> silicon and etched along the {111} plane to form reflecting surfaces at a predetermined angle of 54.7°.

3. The apparatus as defined in claim 1 wherein the enclosure is attached to the interposer using an adhesive that creates a hermetic structure.

4. The apparatus as defined in claim 1 wherein the reflecting surface of the enclosure turning mirror element is coated with a material to increase its reflectivity.

5. The apparatus as defined in claim 4 wherein the reflecting surface is coated with a metallic coating.

6. The apparatus as defined in claim 4 wherein the reflecting surface is coated with a plurality of layers of dielectric material.

7. The apparatus as defined in claim 1 wherein the reflecting surface of the coverplate turning mirror element is coated with a material to increase its reflectivity.

8. The apparatus as defined in claim 7 wherein the reflecting surface is coated with a metallic coating.

9. The apparatus as defined in claim 7 wherein the reflecting surface is coated with a plurality of layers of dielectric material.

10. The apparatus as defined in claim 1 wherein the transparent lid is coated with an anti-reflective material.

11. The apparatus as defined in claim 1 wherein the coverplate includes a transparent lid disposed over and attached to the coverplate silicon sidewall member.

12. An apparatus comprising
an interposer substrate for supporting a plurality of opto-electronic components for creating optical output signals propagating along a longitudinal optical axis
an enclosure covering the interposer substrate, the enclosure including a silicon sidewall member and a transparent lid, the silicon sidewall member etched to include a turning mirror element with a reflecting surface at a predetermined angle θ, the turning mirror element for intercepting the created optical output signals and re-directing the created optical output signals through the transparent lid;
a coverplate disposed over and aligned with the enclosure, the coverplate including a silicon sidewall member etched to include a turning mirror element with a reflecting surface at the same predetermined angle θ, the coverplate turning mirror element for re-directing the optical output signals along the longitudinal axis, the silicon sidewall member further etched to include a pair of angled guiding features disposed on parallel surfaces orthogonal to the turning mirror element; and
a silicon array connector for coupling with the coverplate, the silicon array connector including a plurality of optical signal paths for receiving the output optical signals disposed in a silicon housing, the silicon housing including angled guiding features etched on opposing faces for engaging with the coverplate guiding features and aligning the plurality of optical signal paths with the output optical signals.

13. The apparatus as defined in claim 12 wherein the plurality of optical signal paths in the silicon array connector comprises a plurality of optical fibers.

14. The apparatus as defined in claim 12 wherein the plurality of optical signal paths in the silicon array connector comprises a plurality of integrated optical waveguides formed in a silicon substrate.

15. The apparatus as defined in claim 12 wherein the enclosure silicon sidewall member and the coverplate silicon sidewall member are formed of <100> silicon and etched along the {111} plane to form reflecting surfaces at a predetermined angle of 54.7°.

16. The apparatus as defined in claim 12 wherein the connector array is removably coupled to the coverplate.

17. The apparatus as defined in claim 12 wherein the connector array further comprises a lens array for coupling the optical output signals into the connector array optical signal paths.

18. A method comprising the steps of:
providing an interposer substrate including a plurality of opto-electronic components for creating optical output signals and;
placing an enclosure over the interposer substrate in an aligned arrangement, the enclosure comprising a transparent lid and a silicon sidewall member etched to include a turning mirror element with a reflecting surface at a predetermined angle θ, the turning mirror element aligned with the interposer for intercepting the created optical output signals and re-directing the created optical output signals through the transparent lid;
attaching an aligned silicon coverplate to the transparent lid of the enclosure, the silicon coverplate including a silicon sidewall member etched to include a turning mirror element with a reflecting surface at the same predetermined angle θ, the coverplate turning mirror element for re-directing the optical output signals along the longitudinal axis;
inserting a silicon array connector into coverplate; and
aligning a plurality of optical signal paths in the silicon array connector with the optical output signals.

19. The method as defined in claim 18 wherein the silicon sidewall members are formed of <100> silicon and etched along the {111} crystallographic plane to form a predetermined angle θ of 54.7°.

20. The method as defined in claim 18 wherein the method further includes the step of
coating the enclosure turning mirror reflecting surface and the coverplate turning mirror reflecting surface with a highly reflective material.
